(19) United States
(12) Patent Application Publication
(10) Pub. No.: US 2016/0316737 A1
(43) Pub. Date: Nov. 3, 2016

(54) Multi-Axis Breakaway Joint System For A Boom Of An Agricultural Sprayer

(71) Applicant: CNH Industrial America LLC, New Holland, PA (US)

(72) Inventor: Brian J. Pilney, West Bend, WI (US)

(21) Appl. No.: 15/131,368

(22) Filed: Apr. 18, 2016

Related U.S. Application Data
(60) Provisional application No. 62/153,773, filed on Apr. 28, 2015.

(51) Int. Cl. A01M 7/00; A01C 23/00

(52) U.S. Cl. CPC A01M 7/0078; A01M 7/0053; A01C 23/008

(57) ABSTRACT

A multi-axis breakaway joint system for a boom of an agricultural sprayer is provided that is configured to allow a breakaway boom segment to deflect in compound directions through more than one plane. The multi-axis breakaway joint system may include a compound hinge assembly interconnecting the first and breakaway boom segments. The compound hinge assembly has a first hinge arrangement configured to allow deflection of the breakaway boom segment in a first direction of deflection. A second hinge arrangement is configured to allow deflection of the breakaway boom segment in a second direction of deflection. The first and second hinge arrangements allow for variable amounts of deflection in the first and second directions of deflection with respect to each other.

### CROSS-REFERENCE TO RELATED APPLICATION

The present application claims the benefit of U.S. Ser. No. 62/153,773 filed Apr. 28, 2015.

### FIELD OF THE INVENTION

The invention relates generally to agricultural product application equipment such as self-propelled sprayers and, in particular, to a multi-axis breakaway joint system for a boom of an agricultural sprayer.

### BACKGROUND OF THE INVENTION

Sprayer boom lengths are increasing over time to allow increased coverage in a single spraying pass. The longer booms translate tilting or roll movements of sprayer vehicles into relatively large vertical movements of the tip ends of the booms. Vertical movements of tip ends of the booms can cause the booms to contact the ground during touchdown events. Touchdown events can also happen because the ground under the tip ends of booms can be at different heights than ground at the sprayer vehicles, which can be spaced relatively far away from the sprayer vehicles, especially with recent longer booms. Known sprayer boom breakaway joints are configured to allow breakaway boom segments to pivot through a restricted movement path in a single plane about a hinge axis. Typical sprayer boom breakaway joints have a single hinge with a single pivot axis that defines the single plane movement of the breakaway boom segment, These typical breakaway joints are arranged to allow the breakaway boom segment to pivot at a fixed angle, upwardly and/or rearwardly. However, the upward/rearward fixed angle restricted movement path of the breakaway boom segment may not correspond to the direction of force application to the breakaway boom segment during a collision of the boom or its support wheel with the ground or other obstacle. When misaligned collisions happen, only some of the force may be absorbed by the deflection of the breakaway boom segment through its restricted movement path, and other portions of the force are transmitted through and stressing the breakaway joint and other segments of the boom.

### SUMMARY OF THE INVENTION

A multi-axis breakaway joint system for a boom of an agricultural sprayer is provided that is configured to allow a breakaway boom segment to deflect in compound directions through more than one plane. This may be done by providing first and second links to a breakaway hinge, allowing first and second pivot points. The multi-axis breakaway joint system allows relatively more degrees of freedom of movement of a breakaway boom segment, compared to typical designs, freely accommodating deflection travel directions and distances of the breakaway boom segment based on characteristics of a particular touchdown or collision event.

According to one aspect of the invention, the multi-axis breakaway joint system may include a multi-axis breakaway joint having a compound hinge assembly with multiple hinges. The multi-axis breakaway joint may have two hinges with their pivot axes misaligned, such as arranged perpendicularly with respect to each other. The hinges may include a horizontal hinge as an upward deflection hinge allowing up and down movement of the breakaway boom segment and vertical hinge as a rearward deflection hinge allowing back and forward movement of the breakaway boom segment. The multi-axis breakaway joint allows for simultaneous movement of the breakaway boom segment through multiple planes to provide variable upward and rearward movement distances and variable angles of deflection with respect to the ground.

The multi-axis breakaway joint system may include a coil-over spring damper that is mounted at an angle with respect to both the upward and rearward deflection hinges. The coil-over spring damper cooperates with both the upward and rearward deflection hinges to influence the variable movement of the breakaway boom segment by providing damping and restorative biasing force to damp movements of and restore the breakaway boom segment to a neutral position. This can be done by biasing the breakaway boom segment forward and down to a neutral position of the boom, generally parallel to the ground.

According to another aspect of the invention, a multi-axis breakaway joint system is provided for use with a sprayer boom of an agricultural sprayer. The sprayer boom includes a first boom segment and a second boom segment defining a breakaway boom segment aligned with the first boom segment. The multi-axis breakaway joint system includes a compound hinge assembly interconnecting the first and breakaway boom segments. The compound hinge assembly includes a first hinge arrangement configured to allow deflection of the breakaway boom segment in a first direction of deflection. A second hinge arrangement is configured to allow deflection of the breakaway boom segment in a second direction of deflection. The first and second hinge arrangements allow for variable amounts of deflection in the first and second directions of deflection with respect to each other.

According to another aspect of the invention, the multi-axis breakaway joint system includes an inner bracket assembly connected to the first boom segment, an outer bracket assembly connected to the breakaway boom segment, and an intermediate joint assembly arranged between the inner and outer bracket assemblies. The compound binge assembly is defined at the intermediate joint assembly. The first hinge arrangement may define a first pivot axis and the breakaway boom segment pivots about the first pivot axis when moving in the first direction of deflection. The second hinge arrangement may define a second pivot axis and the breakaway boom segment pivots about the second pivot axis when moving in the second direction of deflection. The first and second pivot axes may be arranged generally orthogonally with respect to each other. The first pivot axis may be generally vertical accommodating generally horizontal movement of the breakaway boom segment and the second pivot axis may be generally horizontal accommodating generally vertical movement of the breakaway boom segment.

According to another aspect invention, the multi-axis breakaway joint system may include an inner bracket assembly connected to the first boom segment. An outer bracket assembly may be connected to the breakaway boom segment. An intermediate joint assembly may be arranged between the inner and outer bracket assemblies. The compound hinge assembly may be defined at the intermediate joint assembly. The first hinge arrangement may be arranged between the inner and intermediate joint assemblies and the second hinge arrangement may be arranged between the outer and intermediate joint assemblies.

The first and second hinge arrangements may define first and second pivot axes arranged perpendicular with respect to each other, and the breakaway boom segment may pivot about first and second axes when moving in the first and second directions of deflection. The intermediate joint assembly may be movable with respect to the inner bracket assembly by way of the first hinge arrangement configured to allow the intermediate joint assembly and breakaway boom segment to pivot about the first pivot axis in unison with each other with respect to the inner bracket assembly. The outer bracket assembly is movable with respect to the intermediate joint assembly by way of the second hinge arrangement and is configured to allow the breakaway boom segment to pivot about the second pivot axis with respect to the intermediate joint assembly.

According to another aspect of the invention, a biasing and damping arrangement extend between the inner and outer bracket assemblies. The biasing and damping arrangement may be configured to bias the breakaway boom segment to a neutral position and damp movement of the breakaway boom segment. The biasing and damping arrangement extend angularly between the inner and outer bracket assemblies and may be a coil over spring damper with a compression spring arranged concentrically outside of a damper.

During a breakaway event, the breakaway boom segment deflects a particular upward distance and a particularly rearward distance, independently of each other, based on the particular direction of force applied to the breakaway boom segment and/or other characteristics of the object that collided with the breakaway boom segment. A relatively more upwardly directed deflection movement path of the breakaway boom segment accommodates primarily upwardly directed threes by pivoting the breakaway boom segment further about the pivot axis of the upward deflection hinge than about the pivot axis of the rearward deflection hinge. A relatively more rearwardly directed deflection movement path of the breakaway boom segment accommodates primarily rearwardly directed forces by pivoting the breakaway boom segment further about the pivot axis of the rearward deflection hinge than about the pivot axis of the upward deflection hinge.

Other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout,

FIG. 1 is a side elevation of a self-propelled sprayer with a multi-axis breakaway joint system according to the present invention;

FIG. 2 is a front elevation of a self-propelled sprayer with multi-axis breakaway joint system according to the present invention;

FIG. 3 is a pictorial view of a multi-axis breakaway joint system according to the present invention;

FIG. 4 is an exploded isometric view of a multi-axis breakaway joint system according to the present invention;

FIG. 5 is an exploded side elevation view of a multi-axis breakaway joint system according to the present invention;

FIG. 6 is an exploded top plan view of a multi-axis breakaway joint system according to the present invention;

FIG. 7 is a side elevation view of a multi-axis breakaway joint system according to the present invention; and

FIG. 8 is a top plan view of a multi-axis breakaway joint system according to the present invention.

### DETAILED DESCRIPTION OF THE PREFERRED EMBODIMENTS

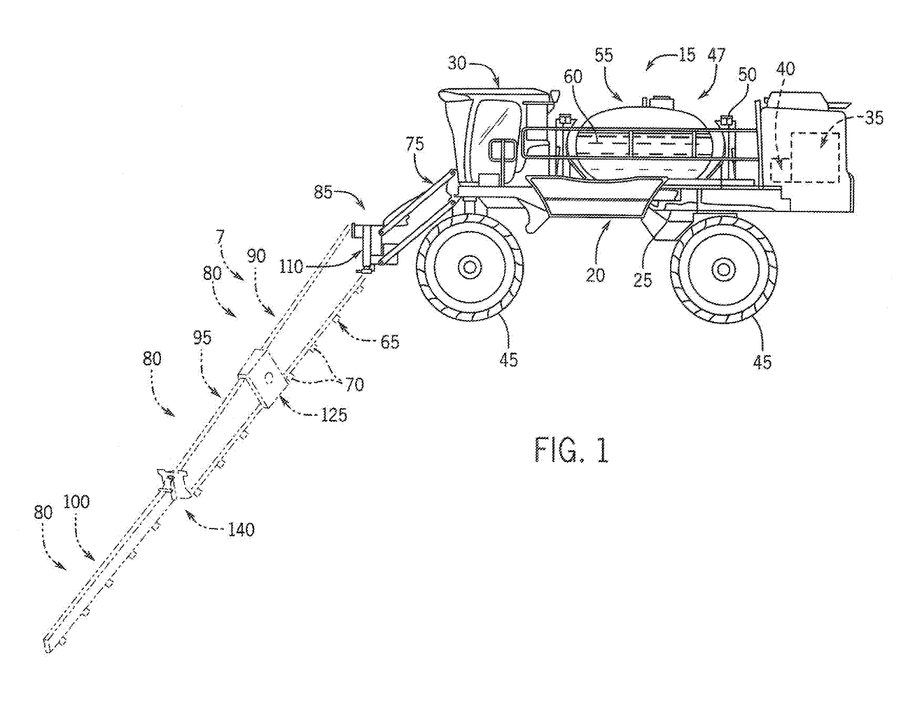

Referring now to the drawings and specifically to FIG. 1, a multi-axis breakaway joint system 5 is shown used with boom 7 for freely accommodating deflection of a breakaway boom segment in a generally unrestricted path(s) by allowing compound movements having both horizontal and vertical breakaway movement components during boom touchdown events, as explained in greater detail elsewhere herein. Multi-axis breakaway joint system 5 and boom 7 are shown incorporated on an agricultural sprayer. The agricultural sprayer is shown here as a self-propelled agricultural sprayer vehicle or self-propelled sprayer 15. Although sprayer 15 is shown as a front-mounted boom self-propelled sprayer, it is understood that self-propelled versions of sprayer 15 can have either front-mounted or rear-mounted booms, such as those available from CNH Industrial, including the Miller Nitro and Condor Series sprayers and New Holland Guardian Series sprayers.

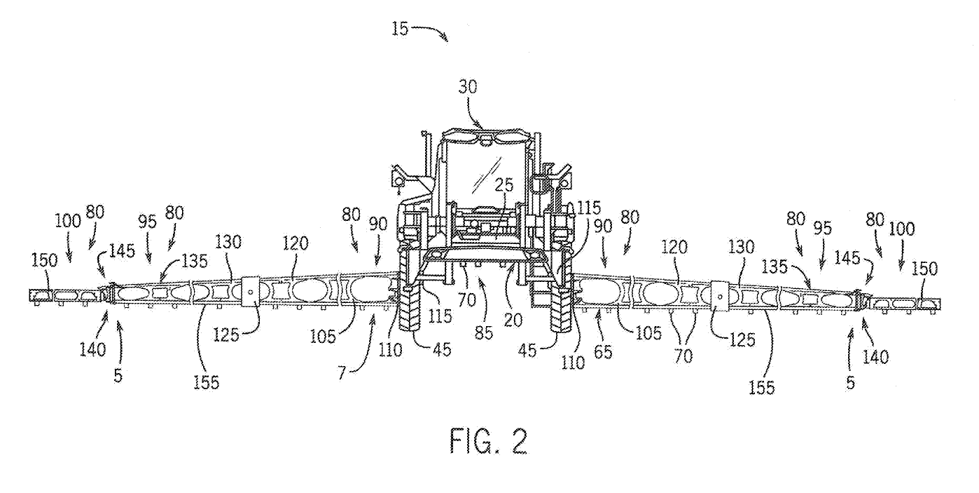

Still referring to FIG. 1, sprayer 15 includes chassis 20 having chassis frame 25 that supports various assemblies, systems, and components. These various assemblies, systems, and components include cab 30, engine 35, and hydraulic system 40. Hydraulic system 40 receives power from engine 35 and includes at least one hydraulic pump which may be in a hydrostat arrangement for providing hydraulic pressure for operating hydraulic components within the hydraulic system 40. For sprayers with hydrostatic drives, hydraulic motors are operably connected to the hydraulic pump(s) for rotating wheels 45. In mechanical drive applications, a mechanical transmission receives power from engine 35 and delivers power for rotating wheels 45 by way of power-transmitting driveline components such as drive shafts, differentials, and other gear sets in portal, drop boxes, or other housings. Spray system 47 includes storage containers such as rinse tank 50 storing water or a rinsing solution, and product tank 55 that stores a volume of product 60 for delivery onto an agricultural field with sprayer 15. Product 60 includes any of a variety of agricultural liquid products, such as various pesticides, herbicides, fungicides, liquid fertilizers, and other liquids including liquid suspensions beneficial for application onto agricultural fields. A product delivery pump conveys product 60 from product tank 55 through plumbing components such as interconnected pieces of tubing and through a boom tubing system 65 for release out of spray nozzles 70 that are spaced from each another along the width of boom 7 during spraying operations of sprayer 15. Referring now to FIG. 2, groups or banks of multiple adjacent spray nozzles 70 define multiple spray sections 72 of spray system 47. Spray sections 72 are defined along boom 7 and selectively deliver product 60 for release onto an agricultural field at locations corresponding to positions of activated spray sections 72. Boom 7 is connected to chassis 20 with lift arm assembly 75 (FIG. 1) that is configured to move the boom 7 up and down for adjusting the height of application of the product 60.

Still referring to FIG. 2, boom 7 includes multiple boom segments 80 connected longitudinally to provide the corresponding width of the assembled boom 7. Boom segments 80 include center section 85 and left and right boom anus extending in opposite directions from, center section 85. Left and right boom arms have multiple segments with pairs of primary boom segments 90, secondary boom segments 95, and breakaway boom segments 100 extending in opposite directions along the respective left and right boom arms minored about a longitudinal axis of the sprayer 15. The corresponding left and right segments of the pairs of primary, secondary, and breakaway boom segments 90, 95, 100 are substantially identical, so only one will be described, with the description applying to both the left and right segments of left and right boom arms. Primary boom segment 90 has a primary boom inner end 105 that is connected with hinge 110 to center section outer end 115, with hinge 110 configured to allow for generally rearward horizontal pivoting of the boom primary, secondary, and breakaway segments 90, 95, 100 toward the chassis 20 when folding boom 7 to achieve a stored position. Primary boom segment 90 extends from primary boom inner end 105 away from center section 85 to primary boom outer end 120. Hinge 125 is arranged between primary boom outer end 120 and secondary boom inner end 130 and is configured to allow for folding the secondary and breakaway segments 95, 100 relative to primary boom segment 90 to achieve the stored position. For horizontal folding of secondary and breakaway segments 95, 100 against the primary boom segment 90, the hinge 125 allows horizontal pivoting of the secondary and breakaway segments 95, 100 toward primary boom segment 90. For vertical folding of secondary and breakaway segments 95, 100 against the primary boom segment 90, the hinge 125 allows vertical pivoting of the secondary and breakaway segments 95, 100 toward primary boom segment 90. Secondary boom segment 95 extends from secondary boom inner end 130 away from primary boom segment 90 to secondary boom outer end 135. Multi-axis breakaway joint system 5 includes multi-axis breakaway joint 140 that is arranged between secondary boom outer end 135 and breakaway boom inner end 145 and is configured to allow for momentary deflecting of the breakaway boom segment 100 away from its outwardly extended position during collisions with the crops, the ground, and/or other obstacles. Breakaway boom segment 100 extends from breakaway boom inner end 145 away from secondary boom segment 95 to breakaway boom outer end 150. In the stored position of boom 7, the secondary and breakaway boom segments 95, 100 are folded against the primary boom segment 90. The primary boom segment 90 is folded toward chassis 20 so that the breakaway boom outer end 150 is near the primary boom inner end 105 tucked toward the front of sprayer 15 with the primary boom outer end 120 and secondary boom inner end 130 tucked toward the back of sprayer 15.

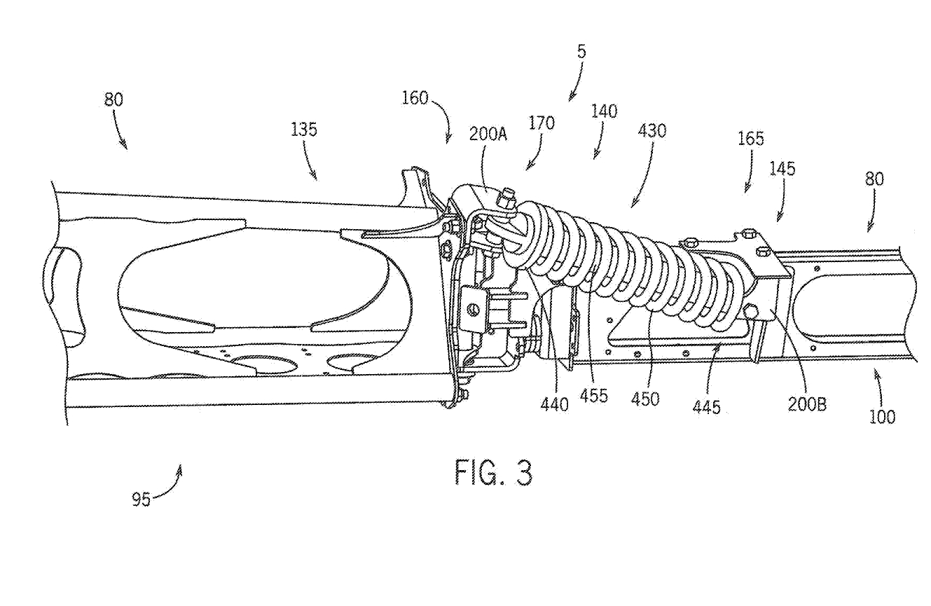

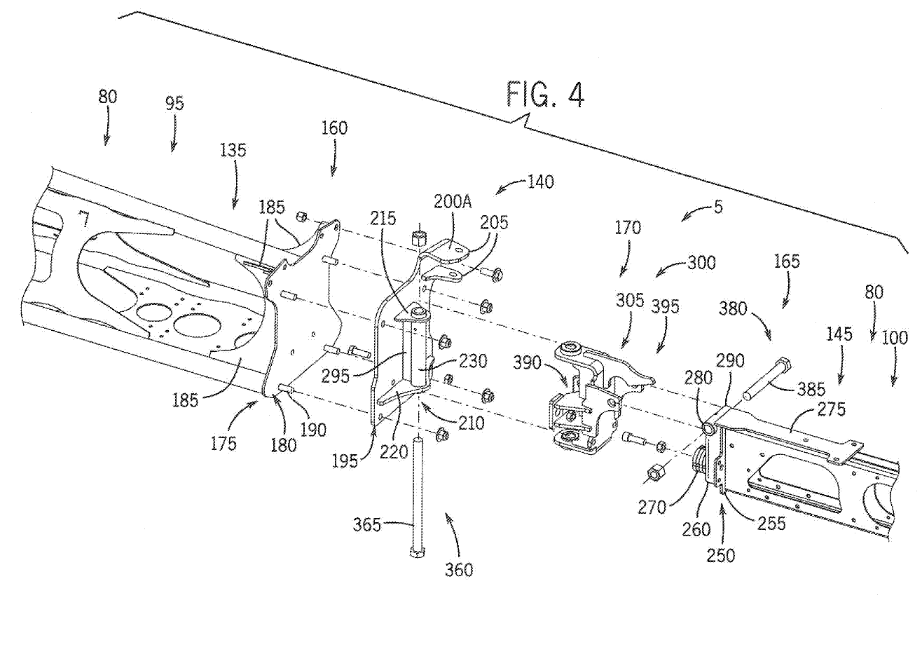

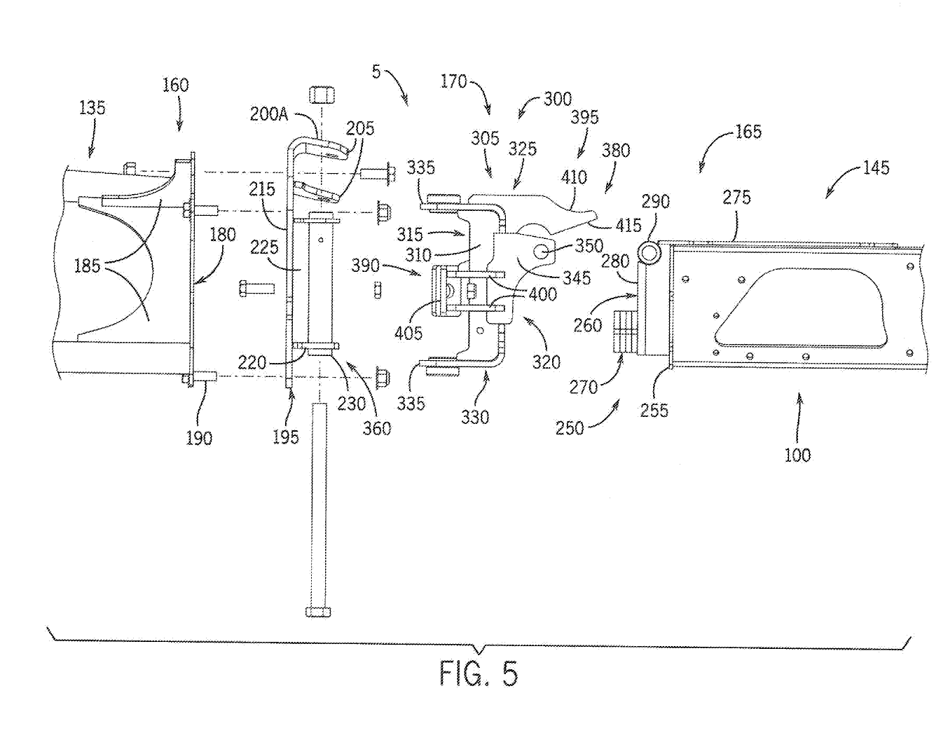

Referring now to FIGS. 3-4, multi-axis breakaway joint 140 includes inner bracket assembly 160 connected a first boom segment 80, shown connected to secondary boom outer end 135. Outer bracket assembly 165 of multi-axis breakaway joint 140 is connected a second boom segment 80, shown connected to breakaway boom inner end 145. Intermediate joint assembly 170 of multi-axis breakaway joint 140 is arranged between and interconnects the inner and outer bracket assemblies 160, 165. Referring now to FIGS. 4-5, inner bracket assembly 160 includes boom segment end cap 175. End cap 175 includes end cap plate 180 with opposite outer and inner surfaces. interconnected gusset plates 185 extend inwardly from the inner surface of end cap plate 180 and are connected to the secondary boom outer end 135. Fasteners 190 extend from the outer surface of end cap plate 180 for connecting end cap hinge plate 195 to end cap plate 180. Shock mount 200A is arranged at an upper portion of the end cap plate 180 and has a pair of tabs 205 with holes to receive a fastener. Hinge support mount 210 is arranged at an intermediate portion of the outer surface of end cap plate 180, Hinge support mount 210 includes horizontally extending upper and lower braces 215, 220 and a vertically extending back brace 225 that collectively support a hinge barrel shown as hinge tube 230 in a generally vertical orientation.

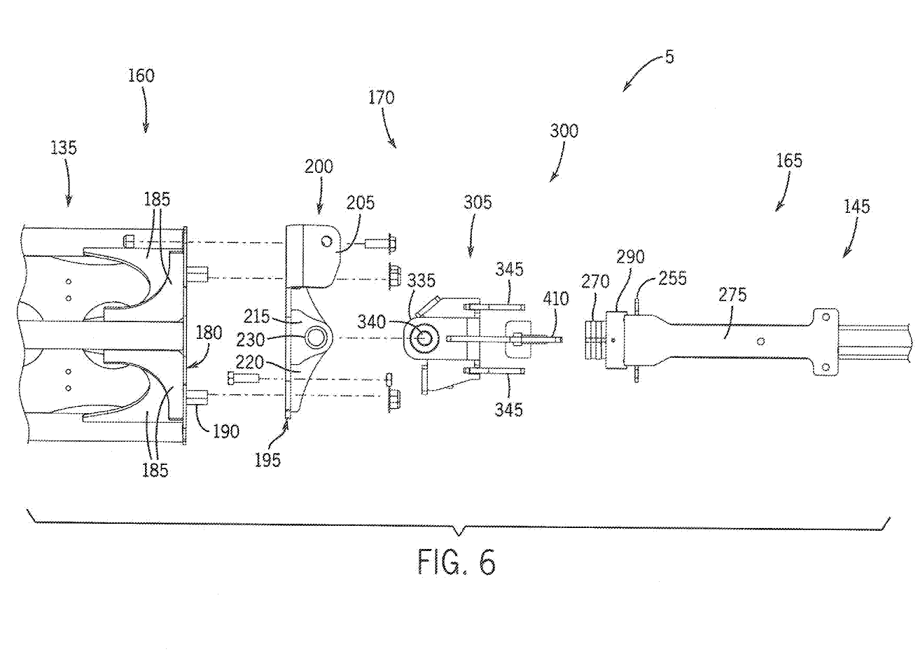

Still referring to FIGS. 4-5, outer bracket assembly 165 includes breakaway boom segment bracket 250 having side plate 255 arranged vertically and connected to an end surface of breakaway boom inner end 145. Box 260 of breakaway boom segment bracket 250 is connected to side plate 255. Stop 270, which may include a rubber contact pad, is attached to a lower segment of box 260. Top plate 275 extends across a portion of an upper surface of the breakaway boom inner end 145 and a portion of an upper surface of side plate 255 and box 260. An upper portion of box 260 has a recess 280 that supports a hinge barrel shown as hinge tube 290 in a generally horizontal orientation. Intermediate joint assembly 170 includes compound hinge assembly 300 which is configured to freely accommodate deflection of breakaway boom segment 100 through multiple links that allow simultaneous up/down movement and back/forward movement, with vertical and horizontal movement components independent of each other. Referring now to FIG. 5, compound hinge assembly 300 includes intermediate hinge body 305 with a base segment 310 and extending generally vertically within the inner side 315 facing inner bracket assembly 160, and outer side 320 facing outer bracket assembly 165 and upper and lower ends 325, 330. Inner hinge tabs 335 with aligned holes 340 (FIG. 6) extend horizontally inward from inner side 315 at upper and lower ends 325, 330 of intermediate hinge body 305. Outer hinge tabs 345 with aligned holes 350 extend vertically outward from outer side 320 of opposites sides of the intermediate hinge body 305.

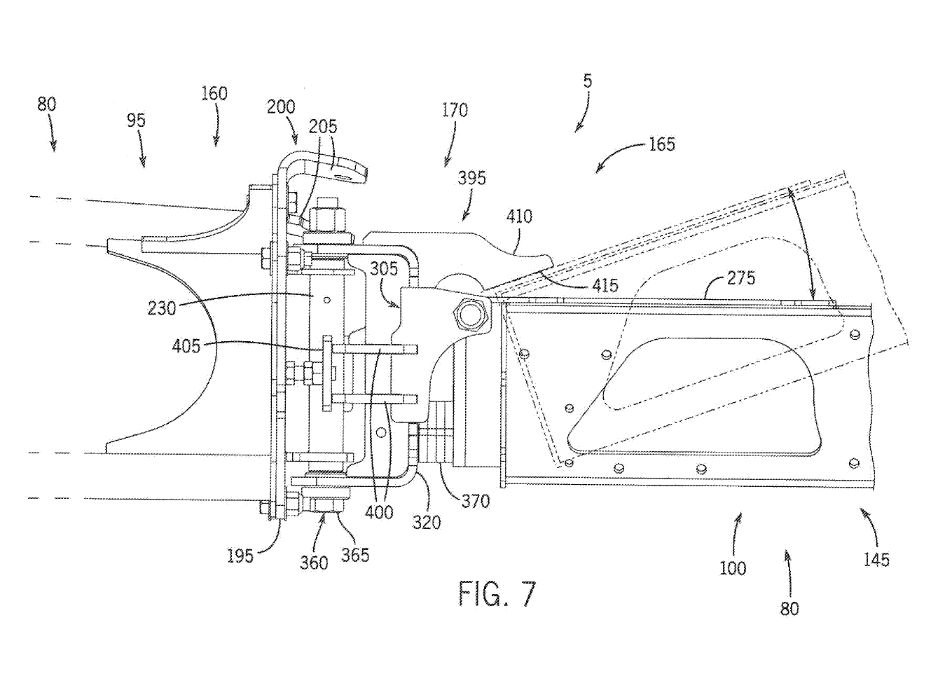

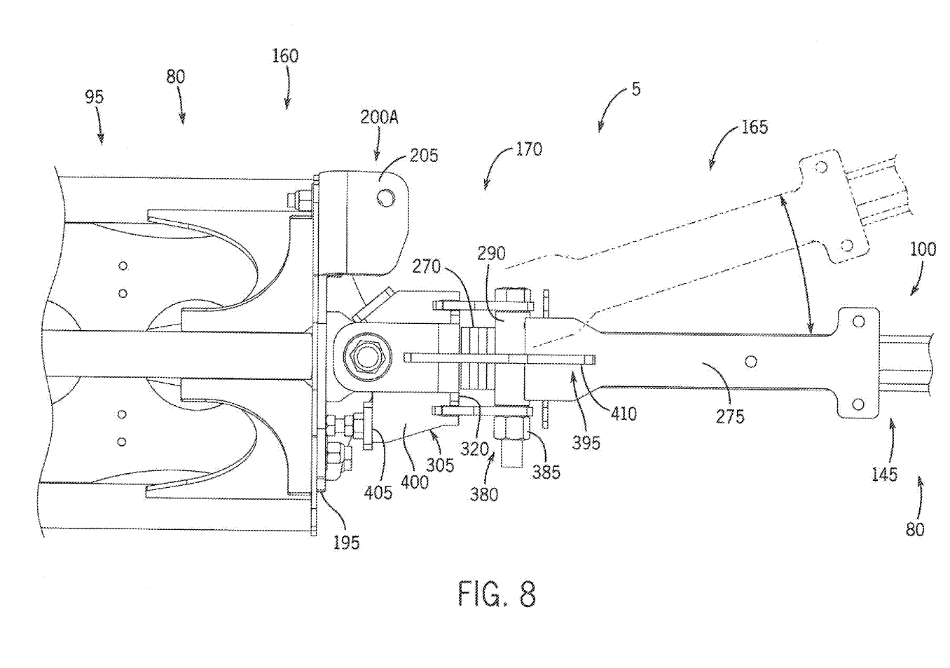

Referring now to FIG. 7, in the assembled compound hinge assembly 300, a first or inner hinge arrangement 360 is defined by inner hinge tabs 335 operably connected to hinge tube 230, with the holes 340 of hinge tabs 335 aligned with a through bore of hinge tube 230 that receives a hinge pin 365 (FIG. 4). Hinge pin 365 defines a pivot axis of inner hinge arrangement 360, shown hem as oriented generally vertical. Referring now to FIG. 8, in the assembled compound hinge assembly 300, a second or outer hinge arrangement 380 is defined by outer hinge tabs 345 operably connected to hinge tube 290, with the holes 350 of hinge tabs 345 aligned with a through bore of hinge tube 290 that receives a hinge pin 385 (FIG. 4). Hinge pin 385 defines a pivot axis of outer hinge arrangement 380, shown here as oriented generally horizontal.

Referring again to FIGS. 4-5, intermediate hinge body 305 includes first and second stop assemblies, shown as inner hinge stop 390 and outer hinge stop 395, that respectively limit travel of inner and outer hinge arrangements 360, 380 while the breakaway boom segment 100 deflects away from a neutral position. Referring now to FIGS. 7-8, when breakaway boom segment 100 is in a neutral or fully extended position, breakaway boom segment 100 extends perpendicularly with respect to a longitudinal axis of sprayer 15, with breakaway boom section 100 extending in longitudinal alignment from secondary boom segment 95. In this neutral position, stop 270 of outer bracket assembly 165 engages outer side 320 of intermediate hinge body 305. Referring now to FIG. 5, inner hinge stop 390 has a pair of hinge stop plates 400 extending horizontally and inwardly from inner side 315 of hinge body 305, with hinge stop plates 400 supporting stop 405 which may include a rubber contact pad. Referring again to FIGS. 7-8, forward horizontal movement of breakaway boom segment 100 is mechanically stopped by contact between stop 405 and end cap hinge plate 195 when breakaway boom segment 100 is in the neutral or fully extended position.

Referring again to FIG. 5, outer hinge stop 395 has a pair of hinge stop plates 410 extending vertically and outwardly from upper end 325 of intermediate hinge body 305, with hinge stop plates 410 having angled lower surfaces or edges 415. Referring again to FIGS. 7-8, upward vertical movement of breakaway boom segment 100 is mechanically stopped by contact between lower edges 415 and top plate 275 when breakaway boom segment 100 is in a fully upward deflected position.

Still referring to FIGS. 7-8, breakaway boom segment 100 is shown in the neutral position with the dashed outline representations of breakaway boom segment 100 showing deflected positions. FIG. 7 shows deflection along an upward deflection direction. FIG. 8 shows deflection along a rearward deflection direction. Breakaway boom segment 100 can move upwardly and rearwardly independent of each other, other than rearward deflection of breakaway boom segment 100 causing angular rotation longitudinal axis of outer hinge arrangement 380 in an arc about the pivot axis of inner hinge arrangement 360, whereby rearward deflection of breakaway boom segment 100 angularly sweeps a plane in which vertical deflection of the breakaway boom segment 100 may occur rearwardly. However, distances of rearward and upward deflections of breakaway boom segment 100 may occur are independent of each other, providing multi-axis movement and variable deflection of breakaway boom segment 100 with two degrees of freedom relative to the remainder of boom 7 and allowing variable amounts of deflection in first and second directions of deflection with respect to each other.

Referring again to FIG. 3, when deflected, breakaway boom segment 100 may be biased back to the neutral position and have its movement damped by a single biasing and damping arrangement 430, shown as coil over spring damper 435 with first end 440 mounted in shock mount 200A arranged at inner bracket assembly 160 and second in 445 mounted in shock mount 200B arranged at an outer bracket assembly 165. Coil over spring damper 435 includes compression spring 450 arranged concentrically outside of damper 455 which may be a hydraulic damper. Coil over spring damper 435 extends angularly between the inner and outer bracket assemblies 160, 165 so that it is arranged to apply a biasing component both down and forward to the breakaway boom segment 100, which biases the breakaway boom segment 100 to its neutral position about both the inner and outer hinge arrangements 360, 380.

Many changes and modifications could be made to the invention without departing from the spirit thereof The scope of these changes will become apparent from the appended claims.

We claim:

1. multi-axis breakaway joint system for use with a sprayer boom of an agricultural sprayer, wherein the sprayer boom includes a first boom segment and a second boom segment defining a breakaway boom segment aligned with the first boom segment, the multi-axis breakaway joint system comprising:
a compound hinge assembly interconnecting the first and breakaway boom semen s, the compound hinge assembly including,
a first hinge arrangement configured to allow deflection of the breakaway boom segment in a first direction of deflection; and
a second hinge arrangement configured to allow deflection of the breakaway boom segment in a second direction of deflection;
wherein the first and second hinge arrangements allow for variable amounts of deflection in the first and second directions of deflection with respect to each other.

2. The multi-axis breakaway joint system of claim 1 further comprising an inner bracket assembly connected to the first boom segment an outer bracket assembly connected to the breakaway boom segment, and an intermediate joint assembly arranged between the inner and outer bracket assemblies, wherein the compound hinge assembly is defined at the intermediate joint assembly.

3. The multi-axis breakaway joint system of claim 2 wherein the first hinge arrangement defines a first pivot axis and the breakaway boom segment pivots about the first pivot axis when moving in the first direction of deflection and wherein the second hinge arrangement defines a second pivot axis and the breakaway boom segment pivots about the second pivot axis when moving in the second direction of deflection.

4. The multi-axis breakaway joint system of claim 3 wherein the first and second pivot axes are arranged generally orthogonally with respect to each other.

5. The multi-axis breakaway joint system of claim 4 wherein the first pivot axis is generally vertical accommodating generally horizontal movement of the breakaway boom segment and the second pivot axis is generally horizontal accommodating generally vertical movement of the breakaway boom segment.

6. The multi-axis breakaway joint system of claim 1 further comprising:
an inner bracket assembly connected to the first boom segment;
an outer bracket assembly connected to the breakaway boom segment; and
an intermediate joint assembly arranged between the inner and outer bracket assemblies;
wherein the compound hinge assembly is defined at the intermediate joint assembly, wherein the first hinge arrangement is arranged between the inner and intermediate joint assemblies and wherein the second hinge arrangement is arranged between the outer and intermediate joint assemblies.

7. The multi-axis breakaway joint system of claim 6 wherein the first and second hinge arrangements define first and second pivot axes arranged perpendicular with respect to each other and wherein the breakaway boom segment pivots about first and second axes when moving in the first and second directions of deflection.

8. The multi-axis breakaway joint system of claim 7 wherein the intermediate joint assembly is movable with respect to the inner bracket assembly by way of the first hinge arrangement configured to allow the intermediate joint assembly and breakaway boom segment to pivot about the first pivot axis in unison with each other with respect to the inner bracket assembly, and wherein the outer bracket assembly is movable with respect to the intermediate joint assembly by way of the second hinge arrangement configured to allow the breakaway boom segment to pivot about the second pivot axis with respect to the intermediate joint assembly.

9. The multi-axis breakaway joint system of claim 1 further comprising a biasing and damping arrangement extending between the inner and outer bracket assemblies, wherein the biasing and damping arrangement is configured to bias the breakaway boom segment to a neutral position and damp movement of the breakaway boom segment.

10. The multi-axis breakaway joint system of claim 9 wherein the biasing and damping arrangement extends angularly between the inner and outer bracket assemblies and includes a coil over spring damper with a compression spring arranged concentrically outside of a damper.

11. An agricultural sprayer, comprising:
a chassis;
a storage container supported by the chassis and configured to store a volume of product for delivery to an agricultural field;
a sprayer boom supported by the chassis and defining spray sections for delivering the product to the agricultural field, wherein the sprayer boom includes a breakaway boom segment at am outermost end of the sprayer boom, an adjacent boom segment arranged inwardly of the breakaway boom segment, and a compound hinge arrangement interconnecting the breakaway boom segment and the adjacent boom segment, and
wherein the compound hinge arrangement is configured to allow deflection of the breakaway boom segment in multiple directions away from a neutral position.

12. The agricultural sprayer of claim II, wherein the compound hinge arrangement includes multiple hinges configured to allow deflection of the breakaway boom segment in multiple directions away from the neutral position independently of each other.

13. The agricultural sprayer of claim 12, wherein the multiple hinges include;
an upward deflection hinge arranged to allow movement of the breakaway boom segment in a generally upward direction away from the neutral position; and
a rearward deflection hinge arranged to allow movement of the breakaway boom segment in a generally rearward direction away from the neutral position.

14. The agricultural sprayer of claim 13, wherein the upward deflection hinge includes a first hinge pin that defines a first pivot axis and the rearward deflection hinge includes a second hinge pin that defines a second pivot axis, and wherein the first and second pivot axes are generally perpendicular to each other.

15. The agricultural sprayer of claim 14, further comprising a biasing and damping arrangement configured to bias the breakaway boom segment toward the neutral position and damp movement of the breakaway boom segment.

16. The agricultural sprayer of claim 15, wherein the biasing and damping arrangement includes a damper that extends at an angle with respect to the first and second hinge pins to damp movement of both the upward deflection hinge and the rearward deflection hinge.

17. The agricultural sprayer of claim 15, wherein the biasing and damping arrangement includes a compression spring arranged concentrically outside of the damper.

18. An agricultural sprayer, comprising:
a chassis;
a storage container supported by the chassis and configured to store a volume of product for delivery to an agricultural field;
a sprayer boom supported by the chassis and defining spray sections for delivering the product to the agricultural field, wherein the sprayer boom includes a first boom segment arranged relatively closer to the chassis, and a second boom segment that defines a breakaway boom segment arranged relatively farther from the chassis; and
a compound hinge arrangement interconnecting the first and breakaway boom segments to each other and configured to allow deflection of the breakaway boom segment in multiple directions away from a neutral position, the compound hinge arrangement including:
an upward deflection hinge arranged to allow movement of the breakaway boom segment in a generally upward direction away from the neutral position; and
a rearward deflection hinge arranged to allow movement of the breakaway boom segment in a generally rearward direction away from the neutral position.

19. The agricultural sprayer of claim 18, further comprising an inner bracket assembly connected to the first boom segment and an outer bracket assembly connected to the breakaway boom segment with the compound hinge an between the inner and outer bracket assemblies, and a biasing and damping arrangement extending between the inner and outer bracket assemblies, wherein the biasing and damping arrangement is configured to bias the breakaway boom segment to a neutral position and damp movement of the breakaway boom segment.

20. The multi-axis breakaway joint system of claim 19 wherein the biasing and damping arrangement extends angularly between the inner and outer bracket assemblies to simultaneously bias the breakaway boom segment to the neutral position through movement of the upward and rearward deflection hinges and damp movement of the breakaway boom segment through the upward and rearward deflection hinges.
